(19) United States
(12) Patent Application Publication
(10) Pub. No.: US 2016/0010800 A1
(43) Pub. Date: Jan. 14, 2016

(54) Liquid Natural Gas Vaporization

(71) Applicant: Lummus Technology, Inc., Bloomfield, NJ (US)

(72) Inventors: Baozhong Zhao, Livingston, NJ (US); Mohamed B. Tolba, Wayne, NJ (US); Howard F. Nichols, Wayne, NJ (US)

(21) Appl. No.: 14/861,439

(22) Filed: Sep. 22, 2015

Related U.S. Application Data
(63) Continuation of application No. 12/788,847, filed on May 27, 2010.

(51) Int. Cl. F17C 7/04

(52) U.S. Cl. CPC F17C 7/04

(57) ABSTRACT

A process for the vaporization of a cryogenic liquid is disclosed. The process may include: combusting a fuel in a burner to produce an exhaust gas; admixing ambient air and the exhaust gas to produce a mixed gas; contacting the mixed gas via indirect heat exchange with a cryogenic liquid to vaporize the cryogenic liquid. Also disclosed is a system for vaporization of a cryogenic liquid. The system may include: one or more burners for combusting a fuel to produce an exhaust gas; one or more inlets for admixing ambient air with the exhaust gas to produce a mixed gas; and one or more heat transfer conduits for indirectly heating a fluid with the mixed gas.

### FIELD OF THE DISCLOSURE

Embodiments disclosed herein relate generally to a natural draft or ambient air vaporizer for use in vaporization of cryogenic fluids, such as liquid natural gas (LNG). More specifically, embodiments disclosed herein relate to a hybrid ambient air/fuel heating system for the vaporization of LNG.

### BACKGROUND

There are times when it is desirable to impart heat from ambient air to a relatively cool liquid to “heat” the liquid. This circumstance can arrive with respect to liquefied natural gas.

The cryogenic liquefaction of natural gas is routinely practiced as a means for converting natural gas into a more convenient form for transportation. Such liquefaction typically reduces the volume by about 600 fold and results in an end product that can be readily stored and transported. Also, it is desirable to store excess natural gas so that it may be easily and efficiently supplied when the demand for natural gas increases. One practical means for transporting natural gas, and also for storing excess natural gas, is to convert the natural gas to a liquefied state for storage and/or transportation and then vaporize the liquid as demand requires.

Natural gas often is available in areas remote from where it will ultimately be used, and therefore the liquefaction of natural gas is of even greater importance. Typically, natural gas is transported via pipeline from the supply source directly to the user market. However, it has become more common that the natural gas be transported from a supply source which is separated by great distances from the user market, where a pipeline is either not available or is impractical. This is particularly true of marine transportation where transport must be made by ocean-going vessels. Ship transportation of natural gas in the gaseous state is generally not practical because of the great volume of the gas in the gaseous state, and because appreciable pressurization is required to significantly reduce the volume of the gas. Therefore, in order to store and transport natural gas, the volume of the gas is typically reduced by cooling the gas to approximately −240° F. to approximately −260° F. At this temperature, the natural gas is converted into liquefied natural gas (LNG), which possesses near atmospheric vapor pressure. Upon completion of transportation and/or storage of the LNG, the LNG must be returned to the gaseous state prior to providing the natural gas to the end user for consumption.

Typically, the re-gasification or vaporization of LNG is achieved through the use of various heat transfer fluids, systems, and processes. For example, some processes used in the art utilize evaporators that employ hot water or steam to heat and vaporize the LNG. These heating processes have drawbacks, as the hot water or steam oftentimes freezes due to the extreme cold temperatures of the LNG, which in turn causes the evaporators to clog. In order to overcome this drawback, alternative evaporators presently used in the art, such as open rack evaporators, intermediate fluid evaporators, submerged combustion evaporators, and ambient air evaporators.

Open rack evaporators typically use sea water or like as a heat source for countercurrent heat exchange with LNG. Similar to the evaporators mentioned above, open rack evaporators tend to “ice up” on the evaporator surface, causing increased resistance to heat transfer. Therefore, open rack evaporators must be designed having evaporators with increased heat transfer area, which entails a higher equipment cost and increased footprint of the evaporator.

Instead of vaporizing LNG by direct heating with water or steam, as described above, evaporators of the intermediate type employ an intermediate fluid or refrigerant such as propane, fluorinated hydrocarbons or the like, having a low freezing point. The refrigerant can be heated with hot water or steam, and then the heated refrigerant or refrigerant mixture is passed through the evaporator and used to vaporize the LNG. Evaporators of this type overcome the icing and freezing episodes that are common in the previously described evaporators, however these intermediate fluid evaporators require a means for heating the refrigerant, such as a boiler or heater. These types of evaporators also have drawbacks because they are very costly to operate due to the fuel consumption of the heating means used to heat the refrigerant.

One practice currently used in the art to overcome the high cost of operating boilers or heaters is the use of water towers, by themselves or in combination with the heaters or boilers, to heat the refrigerant that acts to vaporize the LNG. In these systems, water is passed into a water tower wherein the temperature of the water is elevated. The elevated temperature water is then used to heat the refrigerant such as glycol via a first evaporator, which in turn is used to vaporize the LNG via a second evaporator. These systems also have drawbacks in terms of the buoyancy differential between the tower inlet steam and the tower outlet steam. The heating towers discharge large quantities of cold moist air or effluent that is very heavy compared to the ambient air. Once the cold effluent is discharged from the tower, it tends to want to sink or travel to ground because it is so much heavier than the ambient air. The cold effluent is then drawn into the water tower, hindering the heat exchange properties of the tower and causing tower to be inefficient. The aforementioned buoyancy problem causes the recirculation of cold air through water towers, hindering their ability to heat the water and essentially limiting the effectiveness of the towers.

As yet another alternative, LNG may be vaporized by heating with ambient air. Forced or natural draft type ambient air vaporizers use ambient air as the heat source, passing the ambient air over the heat transfer elements to vaporize the LNG. However, when the weather changes or the vaporizer load changes, the natural gas temperature at the vaporizer outlet may change. In addition, due to the low LNG supply temperature (about −260° F.), significant amounts of ice may form on the heating surface due to the humidity of the ambient air flow.

### SUMMARY OF THE CLAIMED EMBODIMENTS

It has been found that operation of ambient air vaporizers may be greatly improved by use of hybrid ambient air/fuel heating systems as disclosed herein. Hybrid ambient air/fuel heating systems are base loaded with ambient air as a heat source, which may be provided by natural or induced convection. In the hybrid heating systems disclosed herein, the ambient air is mixed, as necessary, with a flue gas from a firebox, where the heat input from the flue gas may be used to decrease, minimize, or negate the impact of variation in ambient conditions on the operation of the vaporizer. Hybrid heating systems may provide for stable vaporizer operations over day/night and summer/winter weather condition changes, may improve turn down ratios as compared to conventional ambient air vaporizers, and may result in no icing or decreased icing as compared to conventional ambient air vaporizers.

In one aspect, embodiments disclosed herein relate to a process for the vaporization of a cryogenic liquid, the process including: combusting a fuel in a burner to produce an exhaust gas; admixing ambient air and the exhaust gas to produce a mixed gas; contacting the mixed gas via indirect heat exchange with a cryogenic liquid to vaporize the cryogenic liquid.

In another aspect, embodiments disclosed herein relate to a system for vaporization of a cryogenic liquid, the system including: one or more burners for combusting a fuel to produce an exhaust gas; one or more inlets for admixing ambient air with the exhaust gas to produce a mixed gas; and one or more heat transfer conduits for indirectly heating a fluid with the mixed gas.

Other aspects and advantages will be apparent from the following description and the appended claims.

### BRIEF DESCRIPTION OF DRAWINGS

FIG. 1 is a simplified schematic of a hybrid ambient air/fuel heating systems according to embodiments disclosed herein.

FIG. 2 is a simplified schematic of a hybrid ambient air/fuel heating systems according to embodiments disclosed herein.

### DETAILED DESCRIPTION

In one aspect, embodiments herein relate to generally to a natural draft or ambient air vaporizer for use in vaporization of cryogenic fluids, such as liquid natural gas (LNG). More specifically, embodiments disclosed herein relate to a hybrid ambient air/fuel heating system for the vaporization of LNG.

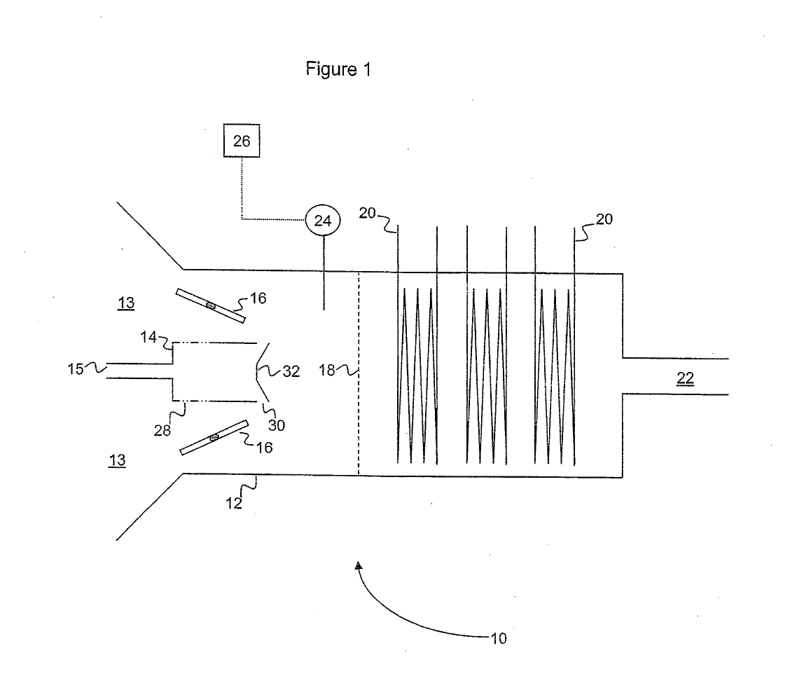

Referring now to FIG. 1, a hybrid ambient air/fuel heating system 10 according to embodiments disclosed herein is illustrated. Heating system 10 may include an outer shell or enclosure 12, ambient air inlets 13, one or more fireboxes 14 with fuel supplied via inlet(s) 15, heating coils 20, and exhaust port 22. In some embodiments, heating system 10 may include one or more of dampers 16, vapor distributor 18, thermocouple 24, and control system 26.

In operation, ambient air is supplied to ports 13 via natural (induced) convection, due to temperature and density gradients resulting from vaporization of a cryogenic liquid passing through heating coils 20, or via forced convection, such as resulting from a fan, blower, pump, or other means for providing a forced vapor flow (not shown). The flow rate of ambient air through inlets 13 may be controlled by varying the speed of the blower, for example, or may be controlled using dampers 16.

A fuel is provided via inlet 15, which combusts in firebox 14 to result in a heated flue gas. Air to firebox 14 may be provided via a separate conduit (not shown) or may be drawn into firebox 14 via inlets 28 from the ambient air flowing through inlets 13. The hot flue gas exits firebox 14 at outlets 30 and mixes with the ambient air.

The mixture of ambient air and hot flue gas may then be passed over heating coils 20 to vaporize a cryogenic liquid, such as LNG fed through the coils. Following heat exchange, the ambient air/flue gas mixture may then exit hybrid heating system 10 via exhaust port 22.

While the heating system of FIG. 1 is illustrated in a horizontal configuration, vertical or other configurations may also be used. The vertical configurations may be upflow or downflow. Any number of heating coils 20 may be used, and may be positioned cross-flow, co-current flow, counter-current flow, or combinations thereof, with the ambient air/flue gas mixture.

The flue gas and ambient air should be adequately mixed prior to contact with heating coils 20. For example, turbulence resulting from forced convection through inlets 13, weirs 32 directing the flow of flue gas through outlets 30, and/or a vapor distributor 18 may be used to provide the desired degree of mixing such that the heating coils 20 are contacted with a vapor mixture having a relatively uniform temperature profile across.

As noted above, the ambient air is mixed with the flue gas to provide a mixed gas for vaporizing the cryogenic liquid, such as LNG. The vaporizer load (e.g., heat input requirements due to demand for natural gas (NG) from the vaporizer) is supplied by the mixed gas. Under certain conditions, sufficient heat input may be available from the ambient air alone, and the rate of fuel to firebox 14 may be shut off or reduced. As conditions warrant, the rate of fuel to firebox 14 may be increased to meet the required vaporizer load. A pilot flame or ignitor (not shown) may be provided for startup of or for the intermittent operation of the firebox when demand warrants increased fuel consumption.

The temperature of the mixed gas may be monitored or controlled, such as by thermocouple 24 and control system 26. Monitoring and control of the temperature of the mixed gas may be used for one or more of: determining if icing or other factors are affecting heat transfer across the heating coils 20, vaporizing the LNG or resulting in a desired temperature difference between the air/flue gas and the LNG/NG, minimizing ice formation on the heating coil surfaces, and, importantly, maintaining the temperature of the mixed gas below the auto-ignition temperature of the cryogenic liquid (such as LNG) in case any leakage occurs within enclosure 12.

The temperature of the vaporized cryogenic liquid may be controlled by adjusting a temperature of the mixed gas by varying a flow rate of fuel to the firebox or burner 14, by adjusting a temperature of the mixed gas by varying a flow rate of ambient air through the one or more inlets 13, by adjusting a flow rate of the cryogenic liquid to the one or more heat transfer conduits 20, or a combination thereof. Such control, monitoring, and adjustment of the flows may be achieved using a control system 26.

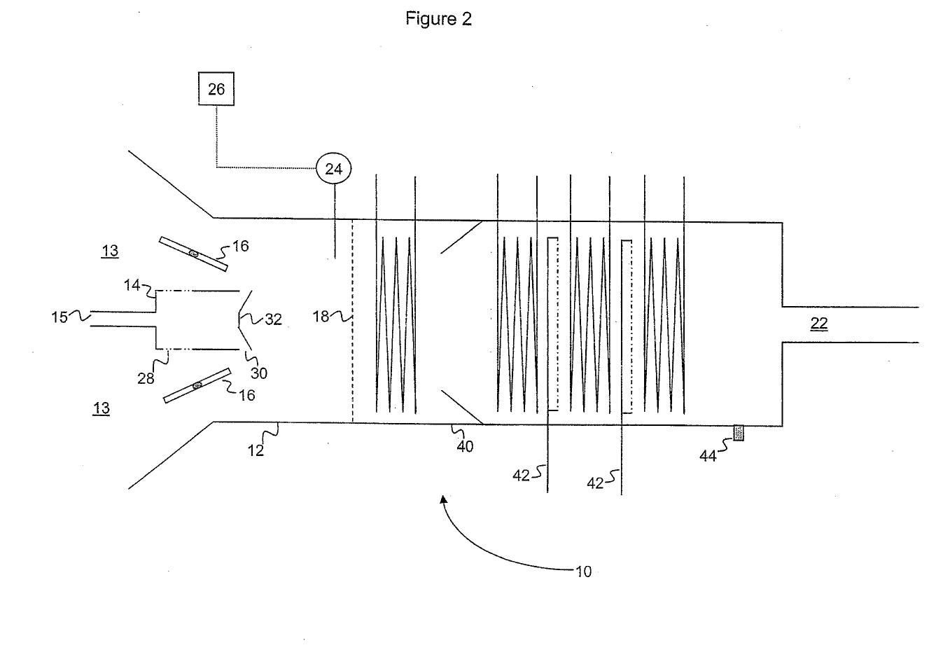

In other embodiments, depending upon the vaporization load requirements and the ambient conditions, part of the mixed gas may bypass one or more of the vaporization coils, such as by being withdrawn from enclosure 12 via outlet 40, as shown in FIG. 2, where like numerals represent like parts. The withdrawn mixed gas may be reintroduced via distributor 42 (bypass) or additional ambient air or flue gas may be introduced, such as by a distributor 42, to influence the NG temperature and the overall performance of heating system 10, as well as to carry out on-line de-icing. Enclosure 12 may also include one or more outlets 44 for withdrawing condensed water that may accumulate within the system.

The layout and design of heating coils 20 may affect ice formation on the heating surfaces and may impact heat transfer efficiency due to eddying. Thus, the type (metal, diameter, thickness, etc.), design, layout, and number of coils used may depend upon the type of ambient air convection (natural or forced), the required heat transfer surface area, seasonal temperature limits, type of fuel available and flue gas temperatures achievable, and other factors known to those skilled in the art. Preferably, the coil layout selected should ensure that the temperature difference between air/flue gas and the LNG/NG is optimized to achieve high heat transfer efficiency and, at the same time, minimize ice formation on the heating coil surfaces.

The hybrid heating systems as described above may be used as stand-alone units or may be configured in a modular design where multiple hybrid heating systems as described above are located proximate one another to meet an overall desired heat transfer load.

As described above, hybrid heating systems according to embodiments disclosed herein utilize both ambient air and flue gas to provide heat for vaporization of a cryogenic fluid, such as liquid natural gas. Such systems may also be used for heating other fluids that are at below-ambient temperatures.

Advantageously, hybrid heating systems according to embodiments disclosed herein use the ambient environment to supply at least a portion of the required heat, thus minimizing pollutant emissions as compared to vaporizers using flue gas alone or a flue gas to heat an intermediate fluid to provide the necessary heat. Heating systems according to embodiments disclosed herein may also result in one or more of: more stable system operations (less impact due to weather changes), lower operation and maintenance cost, lower capital investment costs, reduced occurrence of icing, high thermal efficiency, less environmental impact, and improved turned down ratios as compared to one or more of submerged combustion heaters, open rack vaporizers, fired heaters with an intermediate fluid, and ambient air vaporizers.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A system for vaporization of a cryogenic liquid, the system comprising:
one or more burners for combusting a fuel to produce an exhaust gas;
one or more inlets for admixing, within an enclosure, the exhaust gas with ambient air to produce a mixed gas flowing longitudinally from an upstream end of the enclosure to a downstream end of the enclosure;
a plurality of heat transfer conduits within the enclosure, the plurality of heat transfer conduits containing liquid natural gas and providing heat exchange within the enclosure between the mixed gas and the liquid natural gas;
an outlet disposed intermediate an upstream heat transfer conduit and a first downstream heat transfer conduit to remove a part of the mixed gas from the enclosure, the part of the mixed gas defining a bypass flow of the mixed gas; and
a vapor distributor to distribute the bypass flow of the mixed gas downstream of the first downstream heat transfer conduit.

2. The system of claim 2, further comprising one or more dampers for adjusting a flow rate of the ambient air through the inlets.

3. The system of claim 2, further comprising a thermocouple for measuring a temperature of the mixed gas.

4. The system of claim 2, further comprising a thermocouple for measuring a temperature of the mixed gas.

5. The system of claim 1, further comprising a control system for controlling a temperature of the heated fluid by at least one of:
adjusting a temperature of the mixed gas by varying a flow rate of fuel to the burner;
adjusting a temperature of the mixed gas by varying a flow rate of ambient air through the one or more inlets; and
adjusting a flow rate of the fluid to the one or more heat transfer conduits.

6. The system of claim 1, further comprising a device for introducing the ambient air to the one or more inlets as a forced convection.

7. The system of claim 1, wherein the system is configured to control heat exchange by adjustment of one or more of the exhaust gas, the ambient air, the bypass flow, and a flow of the liquid natural gas.

8. The system of claim 1, wherein the vapor distributor is configured to distribute the bypass flow of the mixed gas downstream of a second heat transfer conduit.

9. A system for vaporization of a cryogenic liquid, the system comprising:
one or more ambient air inlets providing an ambient air flow to an enclosure having an upstream end and a downstream end;
one or more fueled combustion burners configured to provide an exhaust flow to the enclosure, the exhaust flow and the ambient air flow forming within the enclosure a mixed gas flow;
a plurality of heat transfer conduits disposed within the enclosure, the plurality of heat transfer conduits providing heat exchange between the mixed gas flow and a liquid natural gas flow within the heat transfer conduits;
an outlet disposed intermediate an upstream heat transfer conduit and a downstream heat transfer conduit to remove at least a portion of the mixed gas flow from the enclosure, the mixed gas removed defining a bypass flow; and
a vapor distributor configured to distribute the bypass flow downstream of the downstream heat transfer conduit.

10. The system of claim 9, wherein the system is configured to control heat exchange by adjustment of one or more of the exhaust flow, the ambient air flow, the bypass flow, and the liquid natural gas flow.

11. The system of claim 9, further comprising one or more dampers configured to adjust a rate of the ambient air flow through the ambient air inlets.

12. The system of claim 9, further comprising a thermocouple for measuring a temperature of the mixed gas.

13. The system of claim 9, further comprising a control system configured to control a temperature of the liquid natural gas flow by at least one of:
adjusting a temperature of the mixed gas flow by varying a flow rate of fuel to the one or more burners;
adjusting a temperature of the mixed gas flow by varying a flow rate of ambient air through the one or more ambient air inlets; and
adjusting a flow rate of the liquid natural gas to the one or more heat transfer conduits.

14. The system of claim 9, further configured to provide the ambient air flow to the enclosure as a forced convection.

15. The system of claim 9, wherein the mixed gas flow contacting the heat transfer conduits has a substantially uniform temperature profile.

16. The system of claim 9, wherein the plurality of heat transfer conduits are positioned cross-flow, co-current flow, counter-current flow, or combinations thereof, with the mixed gas flow.

17. The system of claim 9, wherein the vapor distributor is configured to distribute the bypass flow downstream of a first downstream heat transfer conduit, downstream of a second heat transfer conduit, or both.

18. A system for vaporization of a cryogenic liquid, the system comprising:
an enclosure having a forced convection ambient air flow provided through one or more ambient air inlets, the enclosure having an upstream end and a downstream end;
one or more dampers configured to adjust a rate of the ambient air flow through the enclosure;
one or more fueled combustion burners providing an exhaust flow to the enclosure, the ambient air flow and the exhaust flow forming within the enclosure a mixed gas flow;
a plurality of heat transfer conduits disposed within the enclosure, the plurality of heat transfer conduits providing heat exchange between the mixed gas flow and a liquid natural gas flow within the heat transfer conduits, the plurality of heat transfer conduits positioned cross-flow, co-current flow, counter-current flow, or combinations thereof, with the mixed gas flow;
an outlet disposed intermediate an upstream heat transfer conduit and a downstream heat transfer conduit to remove at least a portion of the mixed gas flow from the enclosure, the mixed gas removed defining a bypass flow;
a vapor distributor configured to distribute the bypass flow downstream of the downstream heat transfer conduit;
wherein the system is configured to control heat exchange by adjustment of one or more of the exhaust flow, the ambient air flow, and the liquid natural gas flow.

19. The system of claim 18, wherein the mixed gas flow contacting the heat transfer conduits has a substantially uniform temperature profile.

20. The system of claim 18, further comprising a control system configured to control a temperature of the liquid natural gas flow by at least one of:
adjusting a temperature of the mixed gas flow by varying a flow rate of fuel to the one or more burners;
adjusting a temperature of the mixed gas flow by varying a flow rate of ambient air through the one or more ambient air inlets; and
adjusting a flow rate of the liquid natural gas to the one or more heat transfer conduits.
